(19) United States
(12) Patent Application Publication
(10) Pub. No.: US 2025/0266453 A1
(43) Pub. Date: Aug. 21, 2025

(54) NEGATIVE ELECTRODE MATERIAL FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: TDK Corporation, Tokyo (JP)

(72) Inventors: Shin FUJITA, Tokyo (JP); Takashi MORI, Tokyo (JP)

(73) Assignee: TDK Corporation, Tokyo (JP)

(21) Appl. No.: 18/915,405

(22) Filed: Oct. 15, 2024

Related U.S. Application Data
(63) Continuation of application No. PCT/JP2024/005995, filed on Feb. 20, 2024.

(51) Int. Cl. H01M 4/583; H01M 4/02; H01M 4/36; H01M 4/525; H01M 4/60; H01M 4/62; H01M 10/0525

(52) U.S. Cl. CPC H01M 4/583; H01M 4/366; H01M 4/525; H01M 4/602; H01M 4/62; H01M 10/0525; H01M 2004/021; H01M 2004/027

(57) ABSTRACT

This negative electrode material for a lithium ion secondary battery may include a composite particle, a silicon carbide layer, and a coating layer. The composite particle may include amorphous carbonaceous particles and amorphous silicon particles having an average primary particle size of 1 nm or more and 50 nm or less. The silicon carbide layer may be located between the composite particle and the coating layer. A film thickness of the silicon carbide layer may be 1 nm or more and 100 nm or less. The coating layer may include a compound of magnesium or fluorine.

### CROSS-REFERENCE TO RELATED APPLICATION

This application is a continuation application of PCT Application No. PCT/JP2024/005995, filed on Feb. 20, 2024, and the entire contents of which is incorporated herein by reference.

### TECHNICAL FIELD

The present disclosure relates to a negative electrode material for a lithium ion secondary battery, a negative electrode for a lithium ion secondary battery, and a lithium ion secondary battery.

### BACKGROUND ART

Lithium ion secondary batteries are widely used as power sources for mobile devices such as mobile phones and notebook computers and for hybrid cars.

The capacity of a lithium ion secondary battery depends mainly on an active material of an electrode. Graphite is generally used as a negative electrode active material, but there is a demand for a negative electrode active material with a higher capacity. For this reason, silicon (Si), which has a theoretical capacity far higher than that of graphite (372 mAh/g), has attracted attention.

A negative electrode active material including silicon undergoes significant volume expansion during charging. The volume expansion of the negative electrode active material causes a decrease in the cycle characteristics of the battery. When the negative electrode active material expands in volume, for example, the negative electrode active material is damaged, a conductive path between the negative electrode active materials is cut, peeling occurs at an interface between a negative electrode active material layer and a current collector, or cracks occur in a solid electrolyte interphase (SEI) coating film; and thereby, decomposition of an electrolytic solution is caused. This decreases the cycle characteristics of the battery.

For example, Patent Document 1 describes that the cycle characteristics are improved by defining the aspect ratio of a silicon particle and the inclination angle of the silicon particle with respect to the current collector.

### CITATION LIST

### Patent Document

Patent Document 1: Japanese Unexamined Patent Application, First Publication No. 2019-149333

### SUMMARY OF DISCLOSURE

### Technical Problems

The cycle characteristics are an important parameter, and it is desirable to be able to improve the cycle characteristics by a method other than the method described in Patent Document 1.

The present disclosure has been made in view of the above and other problems, and an object of the present disclosure is to provide a lithium ion secondary battery having excellent cycle characteristics.

### Solution to Problems

The following solutions according to some embodiments of the present disclosure are provided to solve the above and other problems.

A negative electrode material for a lithium ion secondary battery according to a first aspect includes a composite particle, a silicon carbide layer, and a coating layer. The composite particle includes amorphous carbonaceous particles and amorphous silicon particles having an average primary particle size of 1 nm or more and 50 nm or less. The silicon carbide layer is located between the composite particle and the coating layer. A film thickness of the silicon carbide layer is 1 nm or more and 100 nm or less. The coating layer includes a compound of magnesium or fluorine.

### Advantageous Effects of Disclosure

A lithium ion secondary battery using the negative electrode material for a lithium ion secondary battery according to some embodiments of the present disclosure has excellent cycle characteristics.

### BRIEF DESCRIPTION OF DRAWINGS

FIG. 1 a cross-sectional view of a negative electrode material for a lithium ion secondary battery according to a first embodiment.

FIG. 2 a schematic diagram of a lithium ion secondary battery according to the first embodiment.

### DESCRIPTION OF EMBODIMENTS

Hereinafter, embodiments will be described in detail with reference to the drawings as appropriate. In the drawings which will be used in the following description, featured portions may be enlarged for convenience in order to make the features easy to understand, and the dimensional ratios of constituent elements may be different from the actual ones. The materials, dimensions, and the like which will be exemplified in the following description are examples, and the present disclosure is not limited thereto and can be appropriately modified and carried out without changing the features of the present disclosure.

### “Negative Electrode Material”

A negative electrode material according to a first embodiment is used in a lithium ion secondary battery and includes silicon particles. The negative electrode material according to the first embodiment functions as, for example, a negative electrode active material.

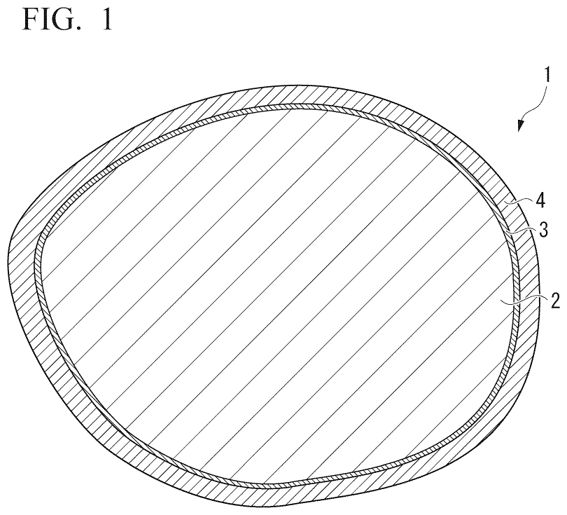

FIG. 1 is a cross-sectional view of a negative electrode material 1 according to the first embodiment. The negative electrode material 1 includes a composite particle 2, a silicon carbide layer 3, and a coating layer 4.

The composite particle 2 is a secondary particle formed by aggregation of a plurality of particles. The average secondary particle size of the composite particles 2 is 1 μm or more and 10 μm or less, preferably 2 μm or more and 8 μm or less, and more preferably 3 μm or more and 7 μm or less.

When the average secondary particle size of the composite particles 2 is within the above-described range, the cycle characteristics are improved. If the composite particle 2 is too small, it becomes difficult to ensure sufficient strength and conductivity when a negative electrode active material layer is formed, and thus the used amounts of a binder and a conductive assistant increase. Since the binder and the conductive assistant are not active materials that perform charging and discharging, if the abundance ratio of these in the negative electrode active material layer increases, the capacity of the lithium ion secondary battery decreases. In addition, if the composite particle 2 is too large, the composite particle 2 is damaged due to expansion and contraction and thus a risk of a side reaction such as decomposition of the electrolytic solution occurring on a new surface generated by the damage increases.

In a case in which the composite particles 2 are available in a particle state, a median size (D50) can be obtained as the average secondary particle size using a particle size distribution measuring device (for example, manufactured by Malvern Panalytical Ltd.). In a case in which the particle size distribution measuring device is used, for example, the average of the particle sizes of 50000 particles is obtained.

In a case in which the composite particles 2 are present in an electrode and it is difficult to separate the composite particles 2 from each other, the average secondary particle size can be obtained using at least 100 composite particles 2 observed in a cross-sectional image. The average secondary particle size measured using the particle size distribution measuring device and the average secondary particle size obtained from the cross-sectional image do not deviate significantly from each other, and they generally match each other.

First, a contrast threshold is set and the composite particles 2 are extracted from the image. Then, the sizes of at least 100 extracted composite particles 2 are obtained. The frequencies of the obtained sizes of the composite particles 2 are plotted graphically, and the most frequent value is taken as the average secondary particle size. In a case in which the shape of the composite particle 2 is irregular, the size of the major axis is used to calculate the average secondary particle size.

The composite particle 2 includes carbonaceous particles and silicon particles. As the weight ratio of the carbonaceous particles and the silicon particles in the composite particle 2, a value obtained by dividing the weight of the carbonaceous particles by the weight of the silicon particles is preferably 0.5 or more and 5 or less. The weight of the carbonaceous particles can be measured by a high-frequency induction heating combustion-infrared absorption method or the like, and the weight of the silicon particles can be measured by an inductively coupled plasma (ICP) emission spectrometry method or the like.

The carbonaceous particles and the silicon particles are each amorphous. Lithium ions enter in an orientation direction of crystals. For this reason, in the crystals, a path through which the lithium ions can enter is limited. In contrast, in the amorphous carbonaceous particles and silicon particles, the crystal direction is not fixed to a predetermined direction, and thus the direction in which the lithium ions enter is not limited. When the carbonaceous particles and the silicon particles constituting the composite particle 2 are amorphous, the diffusion of the lithium ions in the negative electrode material 1 becomes uniform, and a local volume change in the negative electrode material 1 can be suppressed.

The silicon particles may be silicon in the form of a simple substance, may be silicon oxide (SiOₓ: x satisfies, for example, 0.8≤x≤2), or may be a silicon alloy represented by XₙSi. X is a cation. Examples of X include Ba, Mg, Al, Zn, Sn, Ca, V, Cr, Mn, Fe, Co, Ni, Cu, Zn, Ge, Y, Zr, Nb, Mo, W, Au, Ti, Na, K, and the like. n satisfies 0≤n≤0.5.

The average primary particle size of the silicon particles is, for example, 1 nm or more and 50 nm or less, and preferably 3 nm or more and 30 nm or less. The average primary particle size of the silicon particles is obtained from the cross-sectional image of the negative electrode material 1. The cross-sectional image can be obtained using a scanning electron microscope (SEM) or a transmission electron microscope (TEM). For example, the negative electrode material 1 is observed at a magnification of 100000 times using a scanning electron microscope JSM-7600 (manufactured by JEOL Ltd.), and the average primary particle size can be measured by subjecting the captured image to image processing.

The average primary particle size is obtained using image processing software HALCON (registered trademark, manufactured by MVTec Software GmbH). The software recognizes particles in the captured images and removes particles that are not captured in their entirety at the end portion of the observation field of view. Then, the maximum length (a diameter of the circumscribing circle of the particle) is measured for each particle, and the particle size is calculated from the maximum length. Such measurements are carried out for 200 particles to obtain a number-based cumulative particle size distribution, from which the average primary particle size can be calculated.

When the average primary particle size of the silicon particles is within the above-described range, an increase in the coating resistance of the electrolytic solution due to a side reaction caused by contact between the silicon particle and the electrolytic solution can be suppressed. In addition, when the average primary particle size of the silicon particles is within the above-described range, damage to the silicon particle due to expansion and contraction during charging and discharging can be suppressed.

The carbonaceous particles are composited with the silicon particles. Examples of the carbonaceous particles include graphite, graphene, carbides formed after burning pitches, carbides formed after burning resins, and the like. The carbonaceous particles may be of two or more types.

The pitches may be coal-based pitches, petroleum-based pitches, or synthetic pitches, and examples of the pitches include coal tar, light tar oil, medium tar oil, heavy tar oil, naphthalene oil, anthracene oil, coal tar pitch, pitch oil, mesophase pitch, oxygen-crosslinked petroleum pitch, heavy oil, coke, low molecular weight heavy oil, derivatives of these, and the like.

Examples of the resins include a thermoplastic resin such as polyvinyl alcohol, a phenol resin, an epoxy resin, a melamine resin, a urea resin, an aniline resin, a cyanate resin, a furan resin, a ketone resin, an unsaturated polyester resin, a urethane resin, modified products of these, and the like. Examples of the phenol resin include a novolac type phenol resin, a resol type phenol resin, and the like. Examples of the epoxy resin include a bisphenol type epoxy resin, a novolac type epoxy resin, and the like. Examples of the resins include polyethylene, polystyrene, an acrylonitrile-styrene (AS) resin, an acrylonitrile-butadiene-styrene (ABS) resin, polypropylene, polyethylene terephthalate, polycarbonate, polyacetal, polyphenylene ether, polybutylene terephthalate, polyphenylene sulfide, polysulfone, polyether sulfone, polyether ether ketone, polyvinyl chloride, and the like.

The carbonaceous particles preferably include graphite or graphene. The sp² bonds in the graphite or graphene have high electronic conductivity and allow the lithium ions to be supplied uniformly to the silicon particles.

The silicon carbide layer 3 is located between the composite particle 2 and the coating layer 4. The silicon carbide layer 3 covers at least a part of the surface of the composite particle 2. The silicon carbide layer 3 may cover the entire surface of the composite particle 2.

The silicon carbide layer 3 prevents the composite particle 2 from coming into direct contact with the electrolytic solution to cause an irreversible reaction. The irreversible reaction is a reaction in which the electrolytic solution is reductively decomposed. When the irreversible reaction occurs, the amount of the lithium ions in the electrolytic solution is reduced, and the cycle characteristics of the lithium ion secondary battery are decreased. In addition, the silicon carbide layer 3 increases the strength of the composite particle 2 and prevents the negative electrode material 1 from being damaged.

The film thickness of the silicon carbide layer 3 is, for example, 1 nm or more and 100 nm or less, and preferably 3 nm or more and 20 nm or less. The film thickness of the silicon carbide layer 3 is, for example, an average value of the film thicknesses of the silicon carbide layers 3 formed on 100 composite particles 2 obtained from the cross-sectional image. If the film thickness of the silicon carbide layer 3 is within the above-described range, the strength of the negative electrode material 1 can be sufficiently increased while suppressing the irreversible reaction. In addition, if the film thickness of the silicon carbide layer 3 is about 100 nm, the silicon carbide layer 3 does not significantly impede the conduction of the lithium ions.

The coating layer 4 covers the composite particle 2 and the silicon carbide layer 3. The coating layer 4 covers at least a part of the composite particle 2 or the silicon carbide layer 3. The coating layer 4 may completely cover the composite particle 2 and the silicon carbide layer 3.

The coating layer 4 includes a compound of magnesium or fluorine. Examples of the compound of magnesium or fluorine include one or more selected from the group consisting of lithium fluoride (for example, LiF), magnesium oxide (for example, Mg₂O), magnesium phosphate (for example, Mg₃(PO₄)₂), and magnesium fluoride (for example, Mg₂F).

The coating layer 4 prevents the composite particle 2 from coming into direct contact with the electrolytic solution to cause an irreversible reaction. In addition, the compound of magnesium or fluorine reacts with the electrolytic solution to form a high-quality SEI film.

The film thickness of the coating layer 4 is, for example, 10 nm or more and 300 nm or less, preferably 50 nm or more and 200 nm or less, and more preferably 80 nm or more and 150 nm or less. If the film thickness of the coating layer 4 is within this range, a good quality SEI film can be formed and the irreversible reaction of the electrolytic solution can be suppressed. In addition, if the film thickness of the coating layer 4 is about 300 nm, the coating layer 4 does not significantly impede the conduction of the lithium ions. The film thickness of the coating layer 4 is, for example, an average value of the film thicknesses of the coating layers 4 formed on 100 composite particles 2 obtained from the cross-sectional image.

The total film thickness of the silicon carbide layer 3 and the coating layer 4 is, for example, preferably 10 nm or more and 500 nm or less, and more preferably 20 nm or more and 300 nm or less.

The surface of the coating layer 4 may be further coated with carbon or carbon nanotubes. The carbon or carbon nanotubes support the conductivity between the negative electrode materials 1. When the surface of the coating layer 4 is coated with carbon or carbon nanotubes, the conductive network between the negative electrode materials 1 can be easily maintained even in a case in which the volume of the negative electrode material 1 is changed.

The negative electrode material according to the first embodiment can be produced by carrying out a core producing step and a coating layer producing step.

In the core producing step, the composite particle 2 is produced. The composite particle can be produced by mixing the silicon particles and a carbon source in an organic solvent. The weight ratio of the silicon particles and the carbonaceous particles in the composite particle 2 can be adjusted with the mixing ratio of the silicon particles and the carbon source.

Examples of the carbon source include graphite, graphene, pitches, resins, and the like. As the pitches and resins, those described above can be used. The carbon source is preferably at least one selected from the group consisting of graphite, graphene, a novolac-type phenolic resin, a resol-type phenolic resin, a coal-based pitch, and a petroleum-based pitch. Two or more carbon sources may be used. The carbon source affects the powder resistivity of the negative electrode active material.

The organic solvent is, for example, methanol, ethanol, tetrahydrofuran, or the like. A dispersant may be added to the organic solvent. By adding a dispersant, the carbonaceous particles uniformly cover the silicon particles during compositing. Such a composite particle 2 has excellent electronic conductivity and is less likely to cause a side reaction with the electrolytic solution during charging and discharging.

Next, a mixture obtained after the mixing is dried. Through the drying, the organic solvent is removed from the mixture and powder is obtained. A drying method is not particularly limited, but may be, for example, a spray drying method.

Next, the powder obtained after the drying is subjected to a heat treatment. Through the heat treatment step, the resin or resin composition serving as the carbon source burns incompletely and carbonizes to become the carbonaceous particles. In this way, the silicon particles and the carbonaceous particles are composited with each other.

The heat treatment of the mixture is preferably carried out at a heat treatment temperature of 350 to 1200° C. If the heat treatment temperature is low, the carbon source is not sufficiently carbonized, and this may cause lithium to be trapped during charging and discharging. When the lithium is trapped, the initial efficiency of the lithium ion secondary battery is decreased. If the heat treatment temperature is high, the silicon particles react with the carbonaceous particles, and an excess amount of silicon carbide is produced. Among silicon compounds, the silicon carbide has a small contribution to charging and discharging, and reduces the conductivity of the lithium ions, and this causes a decrease in the discharge capacity of the lithium ion secondary battery.

In addition, the heat treatment time is preferably 1 hour or more and 72 hours or less. The heat treatment atmosphere is preferably a reducing atmosphere such as a nitrogen atmosphere or an argon atmosphere.

Next, in the coating layer producing step, a compound including Mg or F is attached to the surface of the composite particle 2. Examples of the compound including Mg or F include lithium fluoride (for example, LiF), magnesium oxide (for example, Mg₂O), magnesium phosphate (for example, Mg₃(PO₄)₂), and magnesium fluoride (for example, Mg₂F).

After the compound including Mg or F is attached to the surface of the composite particle 2, a thermal plasma treatment is carried out. In the thermal plasma treatment, heat is applied to the compound for an instant. This heat causes the silicon and carbon on the surface of the composite particle 2 to react with each other; and thereby, the silicon carbide layer 3 is formed. The compound including Mg or F spreads over the surface of the composite particle 2 to become the coating layer 4.

The negative electrode material according to the first embodiment has excellent cycle characteristics for the lithium ion secondary battery. This is because the negative electrode material includes the predetermined negative electrode material 1. In the negative electrode material 1, the surface thereof is covered with the silicon carbide layer 3 and the coating layer 4, and it is possible to suppress the irreversible reaction between the composite particle 2 and the electrolytic solution. The lithium ions are used in the irreversible reaction of the electrolytic solution, and this causes a decrease in the cycle characteristics of the lithium ion secondary battery. In addition, in the negative electrode material 1, the surface thereof is covered with the silicon carbide layer 3 and the coating layer 4, and thus the negative electrode material 1 is less likely to be damaged. When the negative electrode material 1 is damaged, a new surface is exposed, and this causes an irreversible reaction of the electrolytic solution.

### “Lithium Ion Secondary Battery”

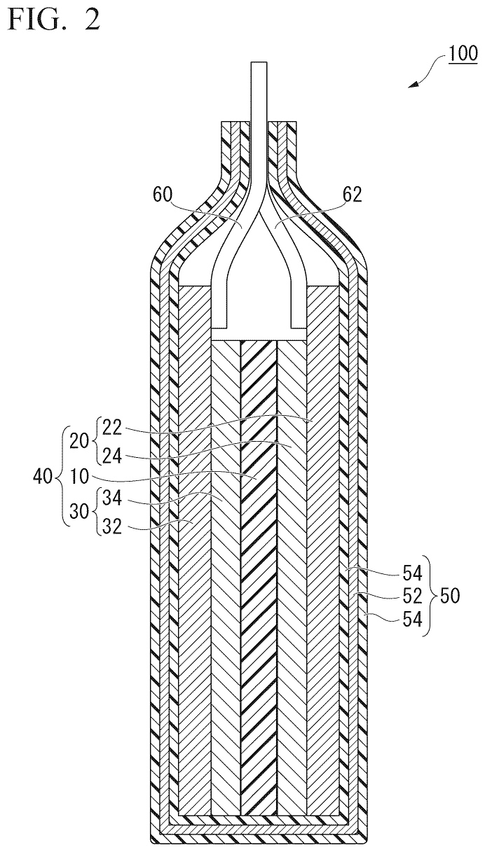

FIG. 2 is a schematic diagram of a lithium ion secondary battery according to the first embodiment. A lithium ion secondary battery 100 shown in FIG. 2 includes a power generating element 40, an exterior body 50, and an electrolyte (for example, a non-aqueous electrolytic solution). The exterior body 50 covers the periphery of the power generating element 40. The power generating element 40 is connected to the outside via a pair of terminals 60 and 62 connected to the power generating element 40. The non-aqueous electrolytic solution is accommodated in the exterior body 50. Although FIG. 2 illustrates an example in which one power generating element 40 is provided inside the exterior body 50, a plurality of power generating elements 40 may be stacked.

### (Power Generating Element)

The power generating element 40 includes a separator 10, a positive electrode 20, and a negative electrode 30. The power generating element 40 may be a laminated body in which these are laminated, or a wound body obtained by winding a structure in which these are laminated.

### <Positive Electrode>

The positive electrode 20 includes, for example, a positive electrode current collector 22 and a positive electrode active material layer 24. The positive electrode active material layer 24 is in contact with at least one surface of the positive electrode current collector 22.

### [Positive Electrode Current Collector]

The positive electrode current collector 22 is, for example, a conductive sheet material. The positive electrode current collector 22 is a thin metal sheet made of, for example, aluminum, copper, nickel, titanium, stainless steel, or the like. Aluminum, which is light in weight, is suitably used for the positive electrode current collector 22. The average thickness of the positive electrode current collector 22 is, for example, 10 μm or more and 30 μm or less.

### [Positive Electrode Active Material Layer]

The positive electrode active material layer 24 includes, for example, a positive electrode active material. The positive electrode active material layer 24 may include a conductive assistant and a binder as necessary.

The positive electrode active material includes an electrode active material capable of reversibly progressing the absorption and release of the lithium ions, the deintercalation and intercalation of the lithium ions, or the doping and dedoping of the lithium ions and counter anions.

The positive electrode active material is, for example, a composite metal oxide. Examples of the composite metal oxide include lithium cobalt oxide (LiCoO₂), lithium nickel oxide (LiNiO₂), lithium manganese oxide (LiMnO₂), spinel lithium manganese oxide (LiMn₂O₄), a compound of a general formula: LiNiₓCo_{y}Mn_{z}MₐO₂ (in the general formula, x+y+z+a=1, 0≤x<1, 0≤y<1, 0≤z<1, 0≤a<1, and M is one or more elements selected from Al, Mg, Nb, Ti, Cu, Zn, and Cr), a lithium vanadium compound (LiV₂O₅), olivine type LiMPO₄ (wherein M represents one or more elements selected from Co, Ni, Mn, Fe, Mg, Nb, Ti, Al, and Zr, or VO), lithium titanate (Li₄Ti₅O₁₂), LiNiₓCo_{y}Al_{z}O₂ (0.9<x+y+z<1.1), and the like. The positive electrode active material may be an organic material. For example, the positive electrode active material may be polyacetylene, polyaniline, polypyrrole, polythiophene, or polyacene.

The positive electrode active material may be a lithium-free material. Examples of the lithium-free material include FeF₃, a conjugated polymer including an organic conductive material, a Chevrel phase compound, a transition metal chalcogenide, a vanadium oxide, a niobium oxide, and the like. As the lithium-free material, only one material may be used, or a plurality of materials may be used in combination with each other. In a case in which the positive electrode active material is the lithium-free material, for example, discharging is first performed. Lithium is intercalated into the positive electrode active material by discharging. In addition, lithium may be chemically or electrochemically pre-doped to the positive electrode active material that is the lithium-free material.

The conductive assistant enhances electronic conductivity between the positive electrode active materials. Examples of the conductive assistant include carbon powder, carbon nanotubes, a carbon material, metal fine powder, a mixture of a carbon material and metal fine powder, a conductive oxide, and the like. Examples of the carbon powder include carbon black, acetylene black, ketjen black, and the like. Examples of the fine metal powder include copper powder, nickel powder, stainless steel powder, iron powder, and the like.

The amount of the conductive assistant in the positive electrode active material layer 24 is not particularly limited. For example, the amount of the conductive assistant relative to the total mass of the positive electrode active material, the conductive assistant, and the binder is 0.5 mass % or more and 20 mass % or less, and preferably 1 mass % or more and 5 mass % or less.

The binder in the positive electrode active material layer 24 binds the positive electrode active materials together. As the binder, a known binder can be used. The binder is preferably one that is insoluble in the electrolytic solution, has oxidation resistance, and has adhesive properties. The binder is, for example, a fluororesin. Examples of the binder include polyvinylidene fluoride (PVDF), polyvinyl alcohol (PVA), polytetrafluoroethylene (PTFE), polyamide (PA), polyimide (PI), polyamideimide (PAI), polybenzimidazole (PBI), polyethersulfone (PES), polyacrylic acid and its copolymers, metal ion crosslinked products of polyacrylic acid and its copolymers, maleic anhydride grafted polypropylene (PP) or polyethylene (PE), and mixtures thereof. The binder used in the positive electrode active material layer is particularly preferably PVDF.

The amount of the binder in the positive electrode active material layer 24 is not particularly limited. For example, the amount of the binder relative to the total mass of the positive electrode active material, the conductive assistant, and the binder is 1 mass % or more and 15 mass % or less, and preferably 1.5 mass % or more and 5 mass % or less. If the amount of the binder is low, the adhesive strength of the positive electrode 20 is weakened. If the amount of the binder is high, the binder is electrochemically inactive and does not contribute to the discharge capacity, and thus the energy density of the lithium ion secondary battery 100 becomes low.

### <Negative Electrode>

The negative electrode 30 includes, for example, a negative electrode current collector 32 and a negative electrode active material layer 34. The negative electrode active material layer 34 is formed on at least one surface of the negative electrode current collector 32.

### [Negative Electrode Current Collector]

The negative electrode current collector 32 is, for example, a conductive sheet material. As the negative electrode current collector 32, a material that is the same as the positive electrode current collector 22 can be used.

### [Negative Electrode Active Material Layer]

The negative electrode active material layer 34 includes a negative electrode active material and a binder. The negative electrode active material layer may include a conductive assistant, a dispersion stabilizer, and the like, as necessary. As the negative electrode active material, the above-mentioned negative electrode material is used. By using the above-mentioned negative electrode material as the negative electrode active material, the cycle characteristics of the lithium ion secondary battery 100 are improved.

As the conductive assistant and the binder, materials that are the same as those of the positive electrode 20 can be used. Examples of the binder in the negative electrode 30 may include cellulose, styrene-butadiene rubber, ethylene-propylene rubber, polyimide resin, polyamide-imide resin, acrylic resin, or the like, in addition to those exemplified for the positive electrode 20. The cellulose may be, for example, carboxymethyl cellulose (CMC).

### <Separator>

The separator 10 is sandwiched between the positive electrode 20 and the negative electrode 30. The separator 10 separates the positive electrode 20 and the negative electrode 30 from each other and prevents a short circuit between the positive electrode 20 and the negative electrode 30. The separator 10 extends in-plane along the positive electrode 20 and the negative electrode 30. The lithium ions can pass through the separator 10.

The separator 10 has, for example, an electrically insulating porous structure. The separator 10 is, for example, a monolayer or laminated body of a polyolefin film. The separator 10 may be a stretched film of a mixture of polyethylene, polypropylene, and the like. The separator 10 may be a nonwoven fabric of a fiber made of at least one constituent material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide-based solid electrolyte, or a sulfide-based solid electrolyte. The separator 10 may be an inorganic coated separator. The inorganic coated separator is formed by applying a mixture of a resin such as PVDF or CMC and an inorganic substance such as alumina or silica on the surface of the above-mentioned film. The inorganic coated separator has excellent heat resistance and suppresses the deposition (precipitation) of a transition metal eluted from the positive electrode onto the surface of the negative electrode.

### <Electrolytic Solution>

The electrolytic solution is enclosed in the exterior body 50 and is impregnated in the power generating element 40. The electrolytic solution is not limited to a liquid electrolyte, but may be a solid electrolyte. The non-aqueous electrolytic solution includes, for example, a non-aqueous solvent and an electrolytic salt. The electrolytic salt is dissolved in the non-aqueous solvent.

The solvent is not particularly limited as long as it is a solvent generally used in the lithium ion secondary battery. The solvent includes, for example, any one of a cyclic carbonate compound, a chain carbonate compound, a cyclic ester compound, and a chain ester compound. The solvent may include these compounds in any mixture ratio. Examples of the cyclic carbonate compound include ethylene carbonate (EC), propylene carbonate (PC), fluoroethylene carbonate, vinylene carbonate, and the like. Examples of the chain carbonate compound include diethyl carbonate (DEC), ethyl methyl carbonate (EMC), and the like. Examples of the cyclic ester compound include γ-butyrolactone, and the like. Examples of the chain ester compound include propyl propionate, ethyl propionate, ethyl acetate, and the like.

The electrolytic salt is, for example, a lithium salt. Examples of the electrolyte include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, LiN(FSO₂)₂, and the like. As the lithium salt, one of these compounds or a mixture of two or more thereof may be used. From the viewpoint of the degree of electrolytic dissociation, the electrolyte preferably includes LiPF₆. The dissociation rate of the electrolytic salt in the carbonate solvent at room temperature is preferably 10% or more.

The electrolytic solution is preferably one in which LiPF₆ is dissolved in the carbonate solvent, for example. The concentration of LiPF₆ is, for example, 1 mol/L. In a case in which the polyimide resin includes a large amount of aromatic, the polyimide resin may exhibit charging behavior similar to that of soft carbon. In a case in which the electrolytic solution is a carbonate electrolytic solution solvent including a cyclic carbonate, lithium can be reacted uniformly with the polyimide. In this case, the cyclic carbonate is preferably ethylene carbonate, fluoroethylene carbonate, or vinylene carbonate.

### <Exterior Body>

The exterior body 50 seals the power generating element 40 and the non-aqueous electrolytic solution therein. The exterior body 50 prevents leakage of the non-aqueous electrolytic solution to the outside and prevents moisture and the like from entering the inside of the lithium ion secondary battery 100 from the outside.

As shown in FIG. 1, the exterior body 50 has a metal foil 52 and a resin layer 54 laminated on each side of the metal foil 52. The exterior body 50 is a metal laminate film in which both sides of the metal foil 52 are coated with a polymer film (the resin layer 54).

The metal foil 52 may be, for example, an aluminum foil. As the resin layer 54, a polymer film such as polypropylene can be used. The material constituting the resin layer 54 may be different between the inner side and the outer side. For example, as the material on the outer side, a polymer with a high melting point, for example, polyethylene terephthalate (PET), polyamide (PA), or the like can be used, and as the material of the polymer film on the inner side, polyethylene (PE), polypropylene (PP), or the like can be used.

### <Terminal>

The terminals 62 and 60 are connected to the positive electrode 20 and the negative electrode 30, respectively. The terminal 62 connected to the positive electrode 20 is a positive terminal, and the terminal 60 connected to the negative electrode 30 is a negative terminal. The terminals 60 and 62 serve to electrically connect the power generating element to the outside. The terminals 60 and 62 are formed from a conductive material such as aluminum, nickel, or copper. A connection method may be welding or screwing. The terminals 60 and 62 are preferably protected with insulating tape to prevent a short circuit.

### “Method of Manufacturing Lithium Ion Secondary Battery”

The lithium ion secondary battery 100 is produced by preparing the negative electrode 30, the positive electrode 20, the separator 10, the electrolytic solution, and the exterior body 50, and assembling them. An example of a method of manufacturing the lithium ion secondary battery 100 will be described below.

The negative electrode 30 is produced, for example, by sequentially carrying out a slurry producing step, an electrode application step, a drying step, and a rolling step.

The slurry producing step is a step of mixing a negative electrode active material, a binder, a conductive assistant, and a solvent to make a slurry. As the negative electrode active material, the above-mentioned negative electrode material is used. When a dispersion stabilizer is added to the slurry, it is possible to suppress aggregation of the negative electrode active material.

The slurry producing step is a step of mixing a negative electrode active material, a binder, a conductive assistant, and a solvent to make a slurry. The solvent is, for example, water, N-methyl-2-pyrrolidone, or the like. The composition ratio, by mass, of the negative electrode active material, the conductive material, and the binder is preferably 70 wt % to 100 wt %: 0 wt % to 10 wt %: 0 wt % to 20 wt %. The mass ratio of these is adjusted such that the total is 100 wt %. A container used for producing the slurry is preferably made of a metal such as SUS.

The negative electrode active material may be a material composited by mixing active material particles and a conductive material while a shearing force is applied thereto. When the active material particles are mixed while the shear force is applied thereto to the extent that the active material particles are not altered, the surfaces of the active material particles are coated with the conductive material. In addition, the particle size of the negative electrode active material can be adjusted by the degree of mixing. In addition, the produced negative electrode active material may be sieved to make the particle size uniform.

The electrode application step is a step of applying the slurry to the surface of the negative electrode current collector 32. A method of applying a slurry is not particularly limited. For example, a slit die coating method or a doctor blade method can be used as the method of applying a slurry. The slurry is applied, for example, at room temperature.

The drying step is a step of removing the solvent from the slurry. For example, the negative electrode current collector 32 on which the slurry is applied is dried in an atmosphere of 80° C. or higher and 350° C. or lower.

The rolling step is carried out as necessary. The rolling step is a step of applying a pressure to the negative electrode active material layer 34 to adjust the density of the negative electrode active material layer 34. The rolling step is carried out, for example, using a roll press apparatus.

The positive electrode 20 can be produced in the same procedure as that for the negative electrode 30. As the separator 10 and the exterior body 50, commercially available products can be used.

Next, the produced positive electrode 20 and negative electrode 30 are laminated such that the separator 10 is located between them; and thereby, the power generating element 40 is produced. In a case in which the power generating element 40 is a wound body, the positive electrode 20, the negative electrode 30, and the separator 10 are wound with one end side thereof as an axis.

Finally, the power generating element 40 is enclosed in the exterior body 50. The non-aqueous electrolytic solution is injected into the exterior body 50. After the non-aqueous electrolytic solution is injected, the pressure is reduced, heating is performed, and the like, and thus the non-aqueous electrolytic solution is impregnated into the power generating element 40. The exterior body 50 is sealed by applying heat or the like; and thereby the lithium ion secondary battery 100 is obtained. Instead of injecting the electrolytic solution into the exterior body 50, the power generating element 40 may be immersed in the electrolytic solution. After the liquid is injected into the power generating element, the power generating element is preferably left to stand for 24 hours.

The lithium ion secondary battery 100 according to the first embodiment has excellent cycle characteristics because the negative electrode active material includes a negative electrode material having a predetermined shape.

The embodiments of the present disclosure have been described in detail with reference to the drawings, but configuration, combinations thereof, and the like in the embodiments are merely examples, and additions, omissions, substitutions, and other modifications in the configurations are possible without departing from the features of the present disclosure.

### EXAMPLES

### Example 1

A positive electrode slurry was applied to one surface of an aluminum foil having a thickness of 15 μm. The positive electrode slurry was produced by mixing a positive electrode active material, a conductive assistant, a binder, and a solvent.

As the positive electrode active material, LiₓCoO₂ was used. As the conductive assistant, acetylene black was used. As the binder, polyvinylidene fluoride (PVDF) was used. As the solvent, N-methyl-2-pyrrolidone was used. The positive electrode slurry was produced by mixing 97 parts by mass of the positive electrode active material, 1 part by mass of the conductive assistant, 2 parts by mass of the binder, and 70 parts by mass of the solvent. The amount of the positive electrode active material carried in a positive electrode active material layer after drying was 25 mg/cm². The solvent was removed from the positive electrode slurry in a drying furnace to make the positive electrode active material layer. The positive electrode active material layer was pressed using a roll press to produce a positive electrode.

Next, a negative electrode active material to be added to a negative electrode slurry was prepared. First, silicon particles having an average primary particle size of 2 nm and a carbon source were mixed and sintered to produce composite particles. The average secondary particle diameter of the composite particles was 8.6 μm.

Next, MgF₂ was attached to the surface of each of the composite particles and the composite particles were subjected to a thermal plasma treatment. The produced negative electrode active material was observed by TEM, and it was observed that a silicon carbide layer and a coating layer were formed. The thickness of the silicon carbide layer was 5 nm, and the film thickness of the coating layer was 152 nm.

Next, the negative electrode slurry was produced using this negative electrode active material. As the conductive assistant, carbon black was used. As the binder, a polyimide resin was used. As the solvent, N-methyl-2-pyrrolidone was used. The negative electrode slurry was produced by mixing 90 parts by mass of the negative electrode active material, 5 parts by mass of the conductive assistant, and 5 parts by mass of the binder in the N-methyl-2-pyrrolidone.

Then, the negative electrode slurry was applied onto one surface of a copper foil having a thickness of 10 μm and dried. The amount of the negative electrode active material carried in a negative electrode active material layer after drying was 2.5 mg/cm². The negative electrode active material layer was pressed using a roll press and then sintered in a nitrogen atmosphere at 300° C. or higher for 5 hours.

Next, an electrolytic solution was produced. In a solvent of the electrolytic solution, fluoroethylene carbonate (FEC):ethylene carbonate (EC):diethyl carbonate (DEC)=10% by volume: 20% by volume: 70% by volume. In addition, an additive for improving output, an additive for suppressing gas, an additive for improving cycle characteristics, and an additive for improving safety performance were added to the electrolytic solution. As an electrolytic salt, LiPF₆ was used. The concentration of LiPF₆ was 1 mol/L.

### (Production of Lithium Ion Secondary Battery for Evaluation)

The produced negative electrode and positive electrode were laminated with a separator (porous polyethylene sheet) interposed between them such that the positive electrode active material layer and the negative electrode active material layer faced each other, to obtain a laminated body. This laminated body was inserted into an exterior body made of an aluminum laminate film and heat-sealed except for one portion on the periphery thereof to form a closed portion. Finally, after the electrolytic solution was injected into the exterior body, a remaining portion was heat-sealed while reducing the pressure using a vacuum sealer, to produce a lithium ion secondary battery. The produced lithium ion secondary battery was left to stand for 24 hours.

(Measurement of Capacity Retention Rate after 300 Cycles)

The cycle characteristics of the lithium ion secondary battery were measured. The cycle characteristics were measured using a secondary battery charging and discharging test device (manufactured by Hokuto Denko Corporation).

The battery was charged at a constant current charge rate of 1 C (a current value at which charging was completed in 1 hour when constant current charging was performed at 25° C.) until a battery voltage reached 4.2 V, and then discharged at a constant current discharge rate of 1.0 C until the battery voltage reached 2.5 V. The discharge capacity after the completion of charging and discharging was detected to obtain a battery capacity Q₁ before the cycle test. The battery capacity Q₁ was 3712 mAh/g.

The battery whose battery capacity Q₁ was obtained above was again charged using the secondary battery charging and discharging test device at a constant current charge rate of 1 C until a battery voltage reached 4.2 V, and then discharged at a constant current discharge rate of 1 C until the battery voltage reached 2.5 V. The above-described charging and discharging was counted as one cycle, and 300 cycles of charging and discharging were performed. Thereafter, the discharge capacity after 300 cycles of charging and discharging was detected to obtain a battery capacity Q₂ after 300 cycles. From the battery capacities Q₁ and Q₂ obtained above, a capacity retention rate E after 300 cycles was obtained. The capacity retention rate E was obtained by E=Q₂/Q₁×100. The capacity retention rate of Example 1 was 93%.

### (Rate Characteristics)

In addition, the rate characteristics of the lithium ion secondary battery were obtained. The rate characteristics were measured using a secondary battery charging and discharging test device. The rate characteristics were evaluated in terms of rate characteristics (%) with a voltage range of 4.2 V to 2.5 V and 1 C=1000 mAh per full cell design capacity. The rate characteristics were the ratio of the discharge capacity when CCCV charging (constant current and constant voltage charging, and an end current value was 0.05 C) was carried out at a current value of 0.2 C and discharging was carried out at a current value of 2 C to the discharge capacity when CCCV charging (constant current and constant voltage charging, and an end current value was 0.05 C) was carried out at a current value of 0.2 C and discharging was carried out at a current value of 0.2 C, and were expressed by the following formula (1).

(2 C capacity retention rate (%))=(2 C discharge capacity)/(0.2 C discharge capacity)×100 (1)

### Examples 2 and 3

Examples 2 and 3 differ from Example 1 in that the average primary particle size of the silicon particles constituting the composite particle was changed. Other conditions were the same as in Example 1, and the capacity retention rate after 300 cycles was obtained.

### Examples 4 to 7

Examples 4 to 7 differ from Example 1 in that the film thickness of the silicon carbide layer was changed. The film thickness of the silicon carbide layer was adjusted by changing the treatment conditions of the thermal plasma treatment. Other conditions were the same as in Example 1, and the capacity retention rate after 300 cycles was obtained.

### Examples 8 and 9

Examples 8 and 9 are different from Example 1 in that the film thickness of the coating layer was changed. The film thickness of the coating layer was adjusted by changing the attached amount of MgF₂. Other conditions were the same as in Example 1, and the capacity retention rate after 300 cycles was obtained.

### Examples 10 and 11

Examples 10 and 11 differ from Example 1 in that the average secondary particle size of the composite particles was changed. The average secondary particle size of the composite particles was changed by adjusting the amounts of the silicon particles and the carbon source when producing the composite particles. Other conditions were the same as in Example 1, and the capacity retention rate after 300 cycles was obtained.

### Examples 12 to 14

Examples 12 to 14 differ from Example 1 in that the compound attached to the surface of the composite particle was changed from MgF₂ to another compound, and a thermal plasma treatment was carried out.

In Example 12, LiF was used instead of MgF₂.

In Example 13, Mg₂O was used instead of MgF₂.

In Example 14, Mg₃(PO₄)₂ was used instead of MgF₂.

Other conditions were the same as in Example 1, and the capacity retention rate after 300 cycles was obtained.

### Example 15

Example 15 differs from Example 1 in that carbon was attached to the surface of the coating layer. The attachment of the carbon was performed by a chemical vapor deposition (CVD) method using acetylene gas. Other conditions were the same as in Example 1, and the capacity retention rate after 300 cycles was obtained.

### Comparative Example 1

Comparative Example 1 differs from Example 1 in that MgF₂ was not attached to the surface after the composite particles were produced. That is, the negative electrode active material of Comparative Example 1 consisted of the composite particles. Other conditions were the same as in Example 1, and the capacity retention rate after 300 cycles was obtained.

### Comparative Examples 2 and 3

Comparative Examples 2 and 3 differ from Example 1 in that the average primary particle size of the silicon particles constituting the composite particle was changed. Other conditions were the same as in Example 1, and the capacity retention rate after 300 cycles was obtained.

### Comparative Examples 4 and 5

Comparative Examples 4 and 5 differ from Example 1 in that the film thickness of the silicon carbide layer was changed. The film thickness of the silicon carbide layer was adjusted by changing the treatment conditions of the thermal plasma treatment. Other conditions were the same as in Example 1, and the capacity retention rate after 300 cycles was obtained.

The results of Examples 1 to 15 and Comparative Examples 1 to 5 were summarized in the following table. The negative electrode active materials of Examples 2 to 15 and Comparative Examples 1 to 5 were also affected by variations in manufacturing conditions in addition to the intentionally changed parameters, and some of them were deviated from the various parameters of the negative electrode active material of Example 1.

TABLE 1

| | | | Silicon | | | | | |
|---|---|---|---|---|---|---|---|---|
| | Average | Average | carbide | | Coating | Carbon | | |
| | secondary | primary | layer | | layer | coating | Capacity | |
| | particle | particle | film | Coating | film | presence | retention | Rate |
| | size | size | thickness | layer | thickness | or | rate | characteristics |
| | (μm) | (nm) | (nm) | material | (nm) | absence | (%) | (%) |
| Example 1 | 8.6 | 2 | 5 | MgF₂ | 152 | Absence | 93 | 91 |
| Example 2 | 8.4 | 1 | 7 | MgF₂ | 68 | Absence | 91 | 90 |
| Example 3 | 7.3 | 50 | 8 | MgF₂ | 81 | Absence | 89 | 90 |
| Example 4 | 4.6 | 24 | 1 | MgF₂ | 114 | Absence | 87 | 93 |
| Example 5 | 5.6 | 4 | 3 | MgF₂ | 149 | Absence | 91 | 94 |
| Example 6 | 3.5 | 3 | 20 | MgF₂ | 258 | Absence | 92 | 92 |
| Example 7 | 6.4 | 15 | 100 | MgF₂ | 214 | Absence | 86 | 88 |
| Example 8 | 4.3 | 45 | 5 | MgF₂ | 10 | Absence | 90 | 93 |
| Example 9 | 5.6 | 5 | 6 | MgF₂ | 300 | Absence | 91 | 89 |
| Example 10 | 1 | 32 | 4 | MgF₂ | 39 | Absence | 89 | 91 |
| Example 11 | 10 | 38 | 5 | MgF₂ | 15 | Absence | 90 | 91 |
| Example 12 | 6.3 | 4 | 14 | LiF | 78 | Absence | 92 | 88 |
| Example 13 | 3.6 | 1 | 12 | Mg₂O | 58 | Absence | 91 | 90 |
| Example 14 | 4.8 | 2 | 7 | Mg₃(PO₄)₂ | 78 | Absence | 90 | 91 |
| Example 15 | 3.4 | 3 | 18 | MgF₂ | 182 | Presence | 92 | 95 |
| Comparative | 6.4 | 10 | — | — | — | Absence | 48 | 91 |
| Example 1 | | | | | | | | |
| Comparative | 4.3 | 60 | 10 | MgF₂ | 85 | Absence | 61 | 82 |
| Example 2 | | | | | | | | |
| Comparative | 5.8 | 0.5 | 10 | MgF₂ | 48 | Absence | 67 | 83 |
| Example 3 | | | | | | | | |
| Comparative | 5.5 | 10 | 0.5 | MgF₂ | 59 | Absence | 61 | 82 |
| Example 4 | | | | | | | | |
| Comparative | 6.7 | 10 | 110 | MgF₂ | 115 | Absence | 57 | 71 |
| Example 5 | | | | | | | | |

Examples 1 to 15 had higher capacity retention rates and better cycle characteristics than Comparative Examples 1 to 4. In Comparative Example 5, the silicon carbide layer was too thick; and therefore, the rate characteristics were decreased.

### REFERENCE SIGNS LIST

1 Negative electrode material
2 Composite particle
3 Silicon carbide layer
4 Coating layer
10 Separator
20 Positive electrode
22 Positive electrode current collector
24 Positive electrode active material layer
30 Negative electrode
32 Negative electrode current collector
34 Negative electrode active material layer
40 Power generating element
50 Exterior body
52 Metal foil
54 Resin layer
60, 62 Terminal
100 Lithium ion secondary battery

1. A negative electrode material for a lithium ion secondary battery, comprising a composite particle, a silicon carbide layer, and a coating layer,
wherein the composite particle includes amorphous carbonaceous particles and amorphous silicon particles, the amorphous silicon particles having an average primary particle size of 1 nm or more and 50 nm or less,
wherein the silicon carbide layer is located between the composite particle and the coating layer,
wherein a film thickness of the silicon carbide layer is 1 nm or more and 100 nm or less, and
wherein the coating layer includes a compound of magnesium or fluorine.

2. The negative electrode material for a lithium ion secondary battery according to claim 1, wherein a total film thickness of the silicon carbide layer and the coating layer is 10 nm or more and 500 nm or less.

3. The negative electrode material for a lithium ion secondary battery according to claim 1, wherein a film thickness of the silicon carbide layer is 3 nm or more and 20 nm or less.

4. The negative electrode material for a lithium ion secondary battery according to claim 1, wherein a thickness of the coating layer is 10 nm or more and 300 nm or less.

5. The negative electrode material for a lithium ion secondary battery according to claim 1, wherein an average secondary particle size of the composite particles is 1 μm or more and 10 μm or less.

6. The negative electrode material for a lithium ion secondary battery according to claim 1, wherein a surface of the coating layer is coated with carbon or carbon nanotubes.

7. The negative electrode material for a lithium ion secondary battery according to claim 1, wherein the compound of magnesium or fluorine is at least one selected from the group consisting of lithium fluoride, magnesium oxide, magnesium phosphate, and magnesium fluoride.

8. The negative electrode material for a lithium ion secondary battery according to claim 1, wherein the amorphous silicon particles comprise silicon in a form of a simple substance; SiOₓ, wherein x satisfies 0.8≤x≤2; or a silicon alloy represented by XₙSi, wherein X is a cation.

9. The negative electrode material for a lithium ion secondary battery according to claim 8, wherein X includes at least one selected from the group consisting of Ba, Mg, Al, Zn, Sn, Ca, V, Cr, Mn, Fe, Co, Ni, Cu, Zn, Ge, Y, Zr, Nb, Mo, W, Au, Ti, Na, and K.

10. The negative electrode material for a lithium ion secondary battery according to claim 1, wherein the amorphous carbonaceous particles include at least one selected from the group consisting of graphite, graphene, carbides formed after burning pitches, and carbides formed after burning resins.

11. The negative electrode material for a lithium ion secondary battery according to claim 10, wherein the amorphous carbonaceous particles include graphite or graphene.

12. The negative electrode material for a lithium ion secondary battery according to claim 10, wherein the pitches comprise at least one selected from the group consisting of coal-based pitches, petroleum-based pitches, and synthetic pitches.

13. The negative electrode material for a lithium ion secondary battery according to claim 12, wherein the pitches includes at least one selected from the group consisting of coal tar, light tar oil, medium tar oil, heavy tar oil, naphthalene oil, anthracene oil, coal tar pitch, pitch oil, mesophase pitch, oxygen-crosslinked petroleum pitch, heavy oil, coke, low molecular weight heavy oil, and derivatives thereof.

14. The negative electrode material for a lithium ion secondary battery according to claim 10, wherein the resins include a thermoplastic resin.

15. The negative electrode material for a lithium ion secondary battery according to claim 14, wherein the resins include at least one selected from the group consisting of a polyvinyl alcohol, a phenol resin, an epoxy resin, a melamine resin, a urea resin, an aniline resin, a cyanate resin, a furan resin, a ketone resin, an unsaturated polyester resin, a urethane resin, and modified products thereof.

16. The negative electrode material for a lithium ion secondary battery according to claim 1, wherein the silicon carbide layer covers an entire surface of the composite particle.

17. The negative electrode material for a lithium ion secondary battery according to claim 4, the thickness of the coating layer is 80 nm or more and 150 nm or less.

18. The negative electrode material for a lithium ion secondary battery according to claim 1, wherein the silicon particles have the average primary particle size of 3 nm or more and 30 nm or less.

19. A negative electrode for a lithium ion secondary battery, comprising the negative electrode material for a lithium ion secondary battery according to claim 1.

20. A lithium ion secondary battery comprising the negative electrode for a lithium ion secondary battery according to claim 19, a positive electrode, and an electrolyte.
